(19) United States
(12) Patent Application Publication
(10) Pub. No.: US 2019/0063133 A1
(43) Pub. Date: Feb. 28, 2019

(54) HINGED STRUCTURE FOR COUNTERS AND CABINETS

(71) Applicant: N.E.M. NORD EST MECCANICA S.N.C.

(72) Inventor: Alessandro CIANETTI, San Pier d'Isonzo (IT)

(21) Appl. No.: 15/766,713

(22) PCT Filed: Oct. 4, 2016
(86) PCT No.: PCT/IT2016/000226

§ 371 Date: Apr. 6, 2018

(30) Foreign Application Priority Data
Oct. 9, 2015 (IT) 102015000060109 9

(51) Int. Cl. E05F 5/08; E05F 5/00; A47F 3/00; E05D 5/02; E05D 11/10

(52) U.S. Cl. CPC E05F 5/08; E05F 5/006; A47F 3/007; A47F 2003/008; E05D 11/1014; E05Y 2900/204; E05Y 2900/202; E05D 5/0246

(57) ABSTRACT

The structure comprising a supporting profile (2) and a retaining profile (3) that rotates with respect to the supporting profile (2); the supporting profile (2) has a first wing (2.1) with a first slipper (5) and at least a second wing (2.2); the retaining profile (3) has a groove (3.1) which lodges the lower part of the plate (1); a slot (3.9) of the retaining profile (3) lodges the free end of the second wing (2.2) of the supporting profile (2); the free end of a wing (3.2) of the retaining profile (3) has a thin layer area (3.4) which lodges a second slipper (10); the free end of the longitudinal axis of the second wing (2.2) of the supporting profile (2) is more external with respect to the longitudinal axis constituting the barycenter of the plate (1); the wing (3.2) of the retaining profile (3) has through threaded holes (3.6, 3.12) which accommodate threaded elements capable of deforming its thin layer area (3.4) by adjusting the interlocking between the two slippers (5, 10).

### TECHNICAL FIELD

This invention is a hinged structure to be used in the counter and cabinet sector for goods' presentation and sale.

### BACKGROUND ART

Counters and cabinets for goods' presentation and sale are always equipped with glass or plastic plates. These display units aim to isolate products from the external environment and/or prevent customers from touching or removing them. Plates are secured in various ways to an upper frame supported by uprights, or to a lower frame fixed to the counter or cabinet.

Among the various lower frame fastening systems, some provide for the opening of each plate towards the customer. This allows for its cleaning and the display or removal of the products on the supporting surface of the counter or cabinet.

Each plate, regardless of the rotation system adopted, must obviously remain closed during the operational phase. This is achieved by moving the plate towards the inner side of the counter, and laying it on supports fixed to the counter itself. Otherwise the plate is kept in vertical position but is secured with safety locks to the counter structure or through specific angle brackets to the fixed plates of the counter. Also latches, locks and interlocking elements in plastic are used to ensure that the plate remains in vertical position during the operational phase.

Among the different lower frame fastening systems with rotation of the plate, the one with a pivoting structure formed by two profiles is famous. The first profile is fixed to the counter body and can be referred to as “base profile” or “supporting profile.” The other profile supports the lower part of the plate and may be called “retaining profile” or simply “plate support profile”. Both profiles extend parallel to the plate. The supporting profile has a protrusion comprising a stem and a substantially round end in cross-section. The retaining profile is provided with a slot, open on one side, sized to accommodate the round end of the supporting profile. The protrusion of the supporting profile is a pivot around whose longitudinal axis the retaining profile and the plate that it supports rotate. The barycenter of the plate is placed on a longitudinal axis parallel to the longitudinal axis of the pivot and superimposed to it. The rotation of the plate towards the customer side ends when a retaining element of the retaining profile lodges in a seat of the supporting profile.

A document disclosing this rotational movement of the plate is DE 102013106025 (A1). The fitting having an immovably first profile fixable at the counter and a plate bearing pivoting second profile, which are connected by a pivot bearing. The supporting profile having at least a first wing and at least a second wing. Beneath the second wing being fixed a damping element. A longitudinal opening on the free end of the first wing lodging a price tag. The free end of the wing of the pivoting profile facing the immovably first profile further presenting a longitudinal opening lodging a slipper. The damping element damps the pivotal movement of the pivoting profile in the predominant part of the movement sequence.

In the well-known lower frame fastening systems that allow for the rotation of the plate many defects were found, among which:
At the opening of the plate, the presence of locks in the inner part of the counter requires the intervention of one operator from the internal part of the counter and of another from the external part to support the plate during its rotation;
The plastic interlocking elements often interfere too much, making it difficult to open or close the plate;
After several hundreds of openings, the interlocking elements wear out preventing the seal of the plate in vertical position;

### DISCLOSURE OF INVENTION

This invention aims at making available to users an improved hinged structure for counters and cabinets that allows for the resolution of the problems highlighted above.

This and other objectives are achieved by the structure in question, as better described in the first claim.

This structure includes a supporting profile and a retaining profile which extend parallel to the plate. The supporting profile has at least a first wing, at least a second wing and at least a third wing. The first wing and the third wing are configured for fastening the structure to the counter or cabinet, respectively, front and support. On the free end of the first wing there is a longitudinal opening, pointed towards the retaining profile, which lodges a first slipper. Below the second wing a silicone gasket is fixed.

The retaining profile has a groove enclosed by two wings inside which the lower part of the plate is locked. The plate is blocked by means of silicone or an insert, consisting of a rectilinear profile. When the insert is used, the plate is locked in the groove by means of studs passing through a set of threaded holes with axis perpendicular to that of the wing of the retaining profile in which they are formed. A slot is present in the retaining profile in the opposite position to that of the groove which lodges the lower part of the plate. This slot lodges the free end of the second wing of the supporting profile. The free end of the second wing of the supporting profile forms a pivot around whose longitudinal axis the retaining profile and the lower plate that it supports rotate. The longitudinal axis of the free end of the second wing of the supporting profile around which rotates the retaining profile is more external than the supporting profile of the longitudinal axis being the barycenter of the plate of a distance “I”.

The free end of the wing of the retaining profile facing towards the supporting profile is linked to the body of the wing itself by means of a thin layer area.

This free end of the wing of the retaining profile facing towards the supporting profile further presents a longitudinal opening which lodges a second slipper. The wing of the retaining profile facing towards the supporting profile presents also threaded holes which lodge threaded elements capable of deforming its thin layer area.

Additional threaded holes are located near the ends of the retaining profile. Each hole lodges the end of a screw. These screws regulate the verticality of the plate acting at the end on the first wing of the supporting profile.

The first and the second slipper are constituted by rectilinear extruded elements of self-lubricating material. A gasket is inserted between the slipper lodged in the free end of the first wing of the supporting profile and the free end of the wing itself. Such gasket is made up of an elastic rectilinear element.

If an insert is used to block the lower part of the plate it presents a longitudinal opening on its upper part adapted to accommodate a frost-free panel; in the absence of the frost-free panel the opening of the slot of the insert is occupied by a longitudinal gasket.

Thanks to the structure in question it is not necessary to move the plate towards the inner part of the counter or cabinet to avoid its opening during the operational phase, nor are necessary internal supports fixed to the counter or cabinet itself. The use of safety locks is no longer necessary, although they should be used in any case by way of precaution. Latches, locks and plastic interlocking elements are no longer required. The plate can be opened by one operator only, who acts from the external part of the counter to support the plate during its rotation.

The guarantee of the vertical seal is obtained thanks to the two self-lubricating slippers. They have interference regulated by the elastic gasket acting on the slipper lodged in the free end of the first wing of the supporting profile. Thus it is easy to open or close the plate.

Moreover, acting only minimally by friction, the self-lubricating slippers wear out only little by significantly increasing the sealing of the plate in vertical position.

### BRIEF DESCRIPTION OF THE DRAWINGS

Further characteristics and advantages of the invention will become more evident from the description of a form of execution, preferred but not exclusive, of the structure in question, illustrated only as a non-limitative indication in the attached drawings, in which:

FIG. 1 shows a perspective view of the structure with closed plate;

FIG. 2 shows an exploded view of the structure;

FIG. 3 shows a rear perspective view of the retaining profile and its enlarged detail;

FIG. 4 shows a cross-section of the structure in question along the A-A plane indicated in FIG. 3, with the closed plate in vertical position;

FIG. 5 illustrates another cross-section of the structure in question, along the A-A plane indicated in FIG. 3, with the closed plate in the open position;

FIG. 6 shows a second perspective view of the structure in question, with the plate in the open position;

FIG. 7 shows a cross section of the structure in question along the B-B plane indicated in FIG. 3 with the retaining profile in the open position;

FIG. 8 shows a cross section of the structure in question along the C-C plane indicated in FIG. 3 with the retaining profile in the open position;

FIG. 9 shows a cross section of the structure in question along the D-D plane indicated in FIG. 3 with the retaining profile in the open position.

### BEST MODE FOR CARRYING OUT THE INVENTION

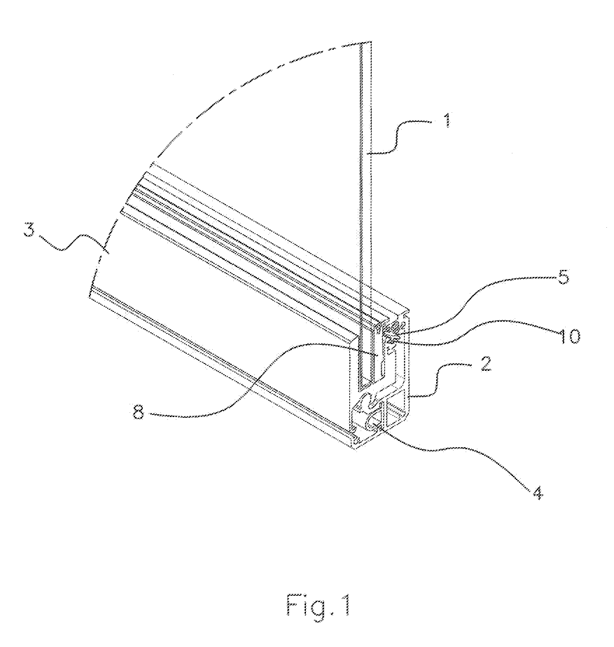

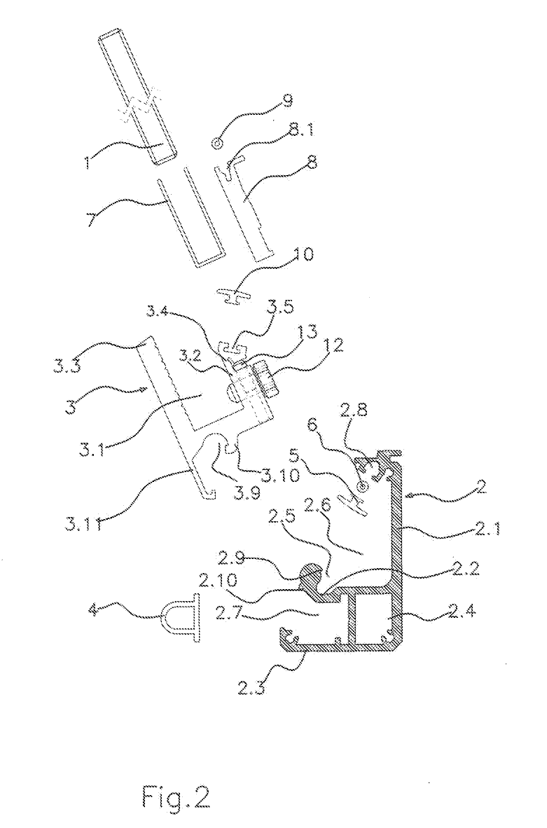

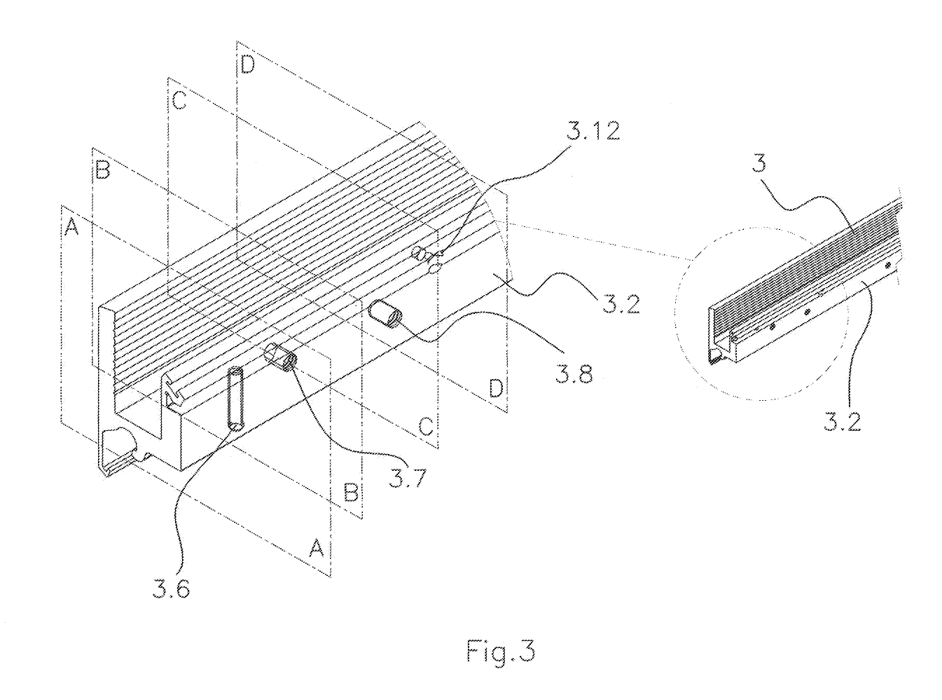

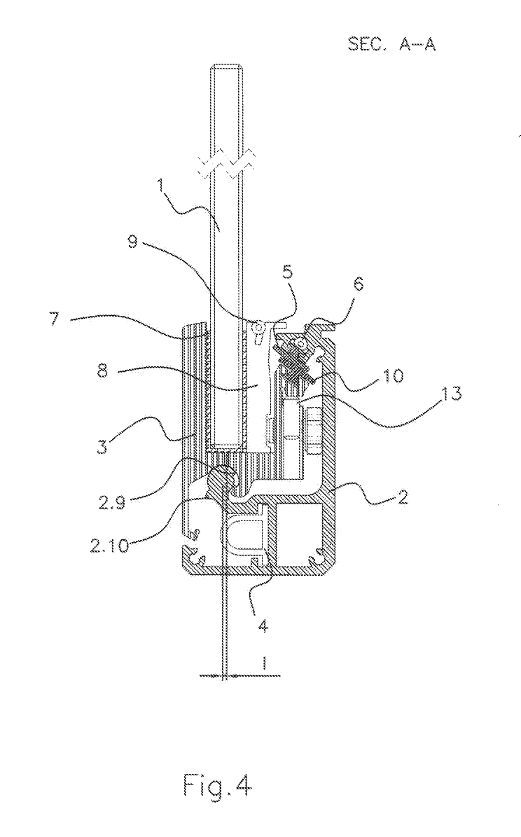

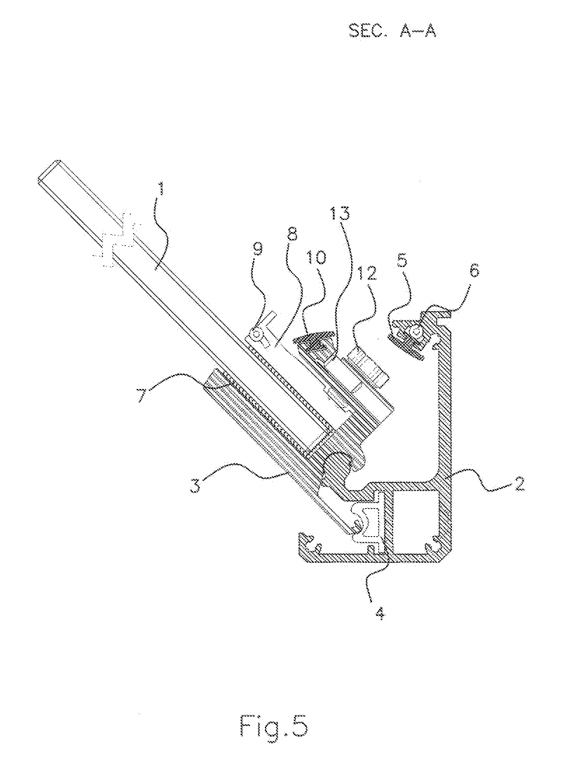

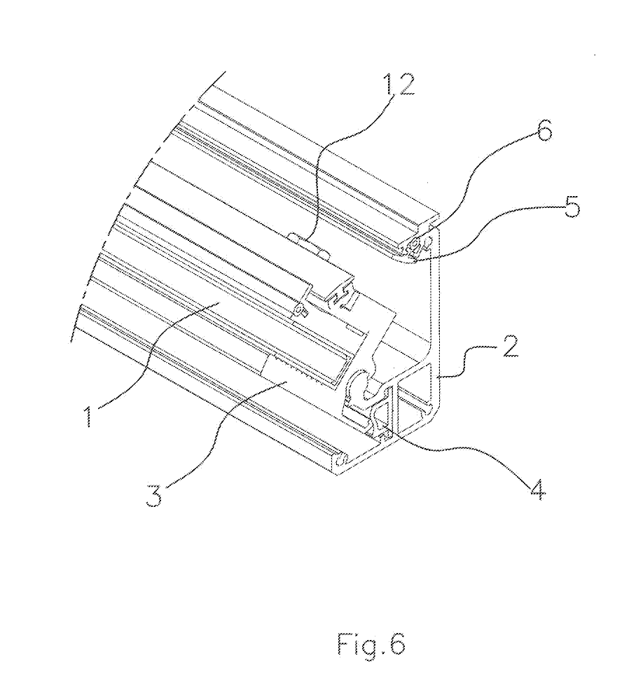

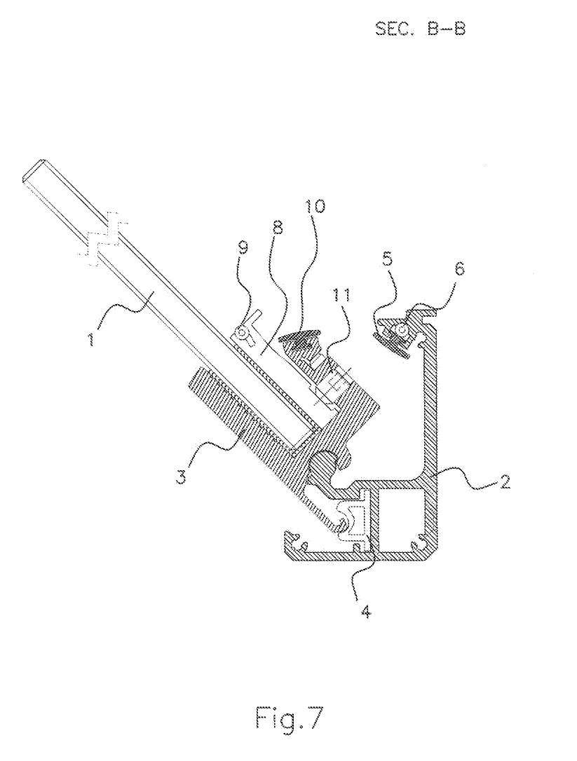

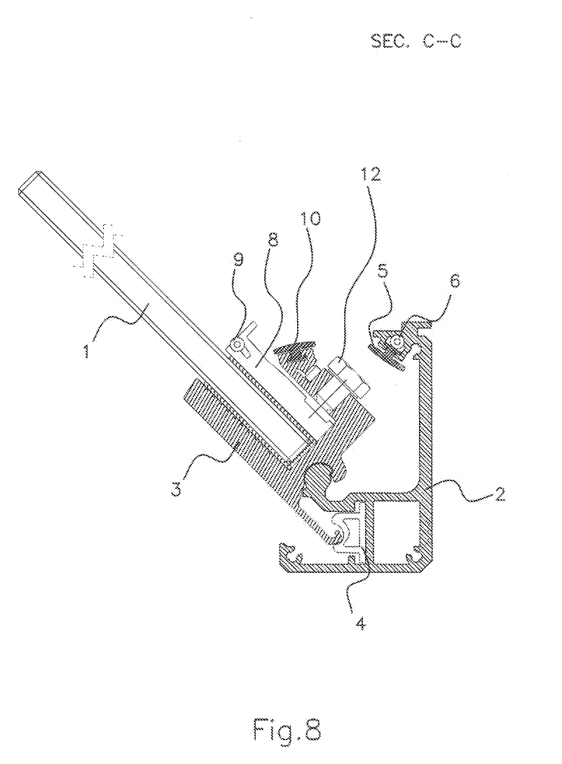

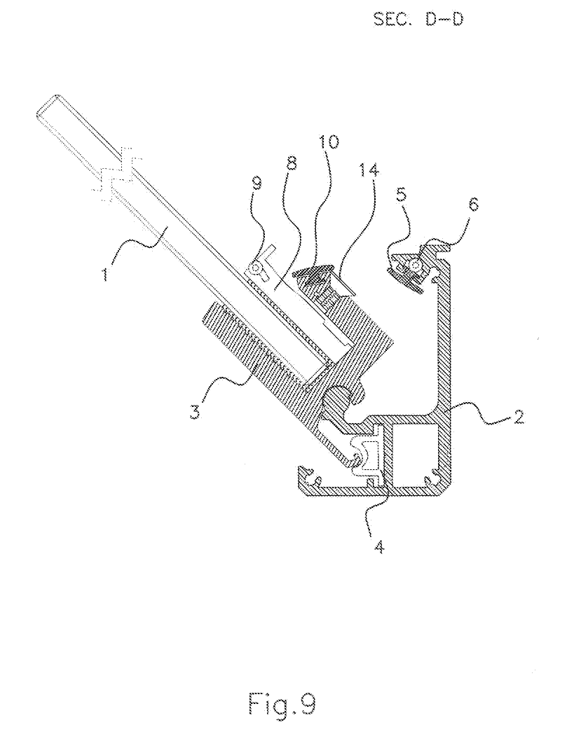

In the preferred realisation described below and illustrated in FIGS. 1-9 the structure according to the invention is used on a counter for products' presentation or sale.

The structure includes a flat glass plate 1, a supporting profile 2 and a retaining profile 3. Both the supporting profile 2 and the retaining profile 3 extend parallel to the plate 1.

The supporting profile 2 has a first wing 2.1, a second wing 2.2 and a third wing 2.3. The first wing 2.1 is fixed frontally to the counter by screws. The second wing 2.2 is interposed between the remaining wings 2.1, 2.3. The three wings 2.1, 2.2, 2.3 protrude from a closed chamber 2.4 that gives rigidity to the supporting profile 2. The second wing 2.2 and the first wing 2.1 delimit a first groove 2.5 and a recess 2.6. The first groove 2.5 is adjacent to the second wing 2.2. The third wing 2.3 and the second wing 2.2 delimit a second groove 2.7. The bottom of the second groove 2.7 lodges a rectilinear silicone gasket 4.

In the free end of the first wing 2.1 of the supporting profile 2 there is a longitudinal opening 2.8. Such opening 2.8 of the first wing 2.1 lodges a slipper 5 and a cushioning gasket 6. The slipper 5 is made up of an extruded rectilinear element in self-lubricating material with a shank and a semicircular head in cross-section. The shank is locked in the opening 2.8 from the ends of the wings which delimit it while the head protrudes from the opening 2.8. In the space between the shank of the slipper 5 and the bottom of the opening the gasket 6 is lodged. Such gasket 6 is made up of an elastic rectilinear element.

The free end of the second wing 2.2 of the supporting profile 2 has a circular surface in cross-section which extends between a detent 2.9 and a safety block 2.10 emerging from the free end itself. The detent 2.9 is facing towards the first wing 2.1 of the supporting profile 2 and the safety block 2.10 is facing towards the opposite direction.

The retaining profile 3 has a groove 3.1 delimited by two wings 3.2, 3.3 within which a U-clamping gasket 7, the lower part of the plate 1, and an insert 8 are lodged. The insert 8 is constituted by a rectilinear profile having a rectangular cross section. A larger face of the insert 8 is adjacent to the bottom of the plate 1 (or, more exactly, to a part of the clamping gasket 7). The other larger face of the insert 8 is adjacent to the internal part of the wing 3.2 of the retaining profile 3 facing towards the first wing 2.1 of the supporting profile 2. An opening 8.1 is present in the superior part of the insert 8, adapted to lodge a frost-free panel. In the absence of the frost-free panel, the opening of the slot 8.1 of the insert 8 is occupied by a longitudinal gasket 9.

The free end of the wing 3.2 of the retaining profile 3 facing towards the first wing 2.1 of the supporting profile 2 is linked to the wing body 3.2 itself by means of a thin layer area 3.4.

This free end of the wing 3.2 presents a longitudinal opening 3.5 having its opening pointing approximately towards the free end of the first wing 2.1 of the supporting profile 2. Such opening 3.5 lodges a further slipper 10 constituted by an extruded rectilinear element in self-lubricating material with a shank and a semicircular head in cross section. The shank of the slipper 10 is locked in the opening 3.5 from the ends of the wings which delimit it while the head protrudes from the opening itself 3.5. The above-mentioned longitudinal opening 2.8 present in the free end of the first wing 2.1 of the supporting profile 2 is facing towards the free end of the wing 3.2 of the retaining profile 3.

The wing 3.2 of the retaining profile 3 facing towards the first wing 2.1 of the supporting profile 2 presents a first set of through threaded holes 3.6, two further threaded holes 3.7 and a second set of through threaded holes 3.8.

The through threaded holes 3.8 of the second set have an axis transversal to that of the wing 3.2 of the retaining profile 3 and each is traversed by a stud 11. The end of the studs 11 pushes the insert 8 against the lower part of the plate 1 and this against the wing 3.3 of the retaining profile 3 most distant from the first wing 2.1 of the supporting profile 2. The retaining profile 3 can thus tighten and hold the plate 1.

The two additional threaded holes 3.7 also have an axis transversal to that of the wing 3.2 of the retaining profile 3 and each threaded hole 3.7 is located near one end of the retaining profile 3. They host the ends of two screws 12 with hexagonal head.

The through threaded holes 3.6 of the first set have an axis orthogonal to that wing 3.2 of the retaining profile 3 and are directed from the wing root 3.2 to its end. Each hole 3.6 is crossed by a stud 13 with slot.

A housing 3.9 is present in the retaining profile 3 in the opposite position to that of the groove 3.1. This housing 3.9 is bounded by two wings 3.10, 3.11, and is open on one side. The wing end 3.10 of the retaining profile 3 facing towards the first wing 2.1 of the supporting profile 2 is shaped like a hook. Such housing 3.9 is sized to house the free end of the second wing 2.2 of the supporting profile 2.

The free end of the second wing 2.2 of the supporting profile 2 forms a pivot around whose longitudinal axis rotate the retaining profile 3 and the plate 1 that it supports. The longitudinal axis of rotation of the free end of the second wing 2.2 of the supporting profile 2 is more external with respect to the first wing 2.1 of the supporting profile 2 of the longitudinal axis constituting the barycenter of the plate 1 of a distance “1”. This offset “1” allows the plate 1 to remain in vertical position even if a safety lock can be inserted.

The retaining profile 3, to which the plate 1 is fixed, is built in the supporting profile 2 in the precise angular position of 24° between the plate 1 and the first wing 2.1 of the supporting profile 2. The housing 3.9 of the retaining profile 3 receives the free end of the second wing 2.2 of the supporting profile 2. The verticality of the plate 1 is then adjusted using the two screws 12 whose head abuts on the first wing 2.1 of the supporting profile 2.

In closing the plate 1, the two self-lubricating slippers 5, 10 begin to come into contact. The slipper 5 linked to the self-lubricating supporting profile 2 gradually gives after the passage of the slipper 10 linked to the retaining profile 3 thanks to the curving inwards of its stem within the opening 2.8 of the supporting profile 2 that lodges it and the deformation of the elastic gasket 6. When exceeding the maximum tangency between the two slippers 5, 10, slipper 10 linked to the retaining profile 3 passes over the slipper 5 linked to the supporting profile 2. The elastic gasket 6, positioned between the slipper 5 and the supporting profile 2, then returns to its original shape by pushing this slipper 5 to the outside of the opening 2.8 and therefore opposing resistance to a potential rotation of the retaining profile 3 towards the outer side of the counter beyond 90°.

It is then set to the slot between the slipper 5 present on the first wing 2.1 of the supporting profile 2 and the slipper 10 positioned on the free end of the wing 3.2 facing towards the inside of the counter of the retaining profile 3. In detail, the tilt of the slipper 10 of the retaining profile 3 is adjusted to maximize the contact area between the two slippers 5, 10 and consequently stiffening safety. This is done by acting on the number of studs 13 lodged within the first set of threaded holes 3.6 having their axis perpendicular to that of the wing 3.2. The ends of the studs 13 push against the free end of the wing 3.2 facing towards the first wing 2.1 of the supporting profile 2 and cause its rotation in one direction by deforming the thin layer area 3.4.

Once the two profiles 2, 3 are built and the above described adjustments on the screws 12 and on the studs 13 are carried out, the structure in question is operative. The plate 1 can be opened by forcing the contrast between the two slippers 5, 10. At the end of the rotation of the opening of the plate 1 the safety block 2.10 most distant from the first wing 2.1 of the supporting profile 2 of the free end of the second wing 2.2 of the supporting profile 2 bumps into the housing 3.9 of the retaining profile 3. At the same time the end of the wing 3.11 of the retaining profile 3 most distant from the first wing 2.1 of the supporting profile 2 bumps into the silicone gasket 4 placed on the bottom of the groove 2.7 of the supporting profile 2. A stroke cushioning effect is thus obtained eliminating noises of contact between the metal parts and cushioning even in small part the possible collision between the two profiles 2, 3. The detent 2.9 facing towards the first wing 2.1 of the supporting profile 2 of the free end of the second wing 2.2 of the supporting profile 2 bumps into the hook-shaped free end of the wing 3.10 of the retaining profile 3 facing towards the first wing 2.1 of the supporting profile 2. This avoids that the plate 1 can rotate outwardly beyond a certain angle.

During the closing phase the hook-shaped free end of the wing 3.10 of the retaining profile 3 is partially located within the first groove 2.5 adjacent to the second wing 2.2 of the supporting profile 2.

An alternative embodiment of the wing 3.2 of the retaining profile 3 facing towards the first wing 2.1 of the supporting profile 2 further presents a third set of through threaded holes 3.12. The through threaded holes 3.12 of the third set have longitudinal axis transversal to that of the wing 3.2 of the retaining profile 3 and extend from one side of the wing to the other 3.2 near its thin layer zone 3.4. Each hole 3.12 of the third set is traversed by a screw with a countersunk head 14. The countersunk head of each screw 14 pushes against the free end of the wing 3.2 facing the first wing 2.1 of the supporting profile 2 and causes its rotation in one direction by deforming the thin layer area 3.4.

Such hinged structure is subject to further numerous modifications and variants falling within the scope of the invention concept. Moreover, all details are replaceable with others technically equivalent.

1- Hinged structure for counters and cabinets provided with at least one plate (1) intended for goods' presentation or sale, comprising a supporting profile (2) and a retaining profile (3) both extending parallel to the plate (1); the supporting profile (2) having at least a first wing (2.1), at least a second wing (2.2) and at least a third wing (2.3) where the second wing (2.2) being interposed between the remaining wings (2.1, 2.3); said first wing (2.1) being arranged to the front fastening to the counter or cabinet and said third wing (2.3) being arranged to the support fastening to the counter or cabinet; below the second wing (2.2) a silicone gasket (4) being fixed; the first wing (2.1) having in its free end a longitudinal opening (2.8); said retaining profile (3) having a groove (3.1) delimited by two wings (3.2, 3.3) which lodges the lower part of the plate (1); the free end of the wing (3.2) of the retaining profile (3) facing towards the first wing (2.1) of the supporting profile (2) having a longitudinal opening (3.5); said opening (3.5) lodging a slipper (10); the retaining profile (3) having a slot (3.9) in a position opposite to that of the groove (3.1); said slot (3.9) of the retaining profile (3) lodging the free end of the second wing (2.2) of the supporting profile (2); said free end of the second wing (2.2) forming a pivot around whose longitudinal axis rotate the retaining profile (3) and the plate (1) it supports; said structure being characterized in that the longitudinal axis of the said free end of the second wing (2.2) of the supporting profile (2) is more external with respect to the first wing (2.1) of the supporting profile (2) of the longitudinal axis being the barycenter of the plate (1) by a distance “1” and in that said free end of the wing (3.2) of the retaining profile (3) facing towards the first wing (2.1) of the supporting profile (2) being linked to the body of the wing (3.2) by means of a thin layer area (3.4); said wing (3.2) of the retaining profile (3) facing towards the first wing (2.1) of the supporting profile (2) presenting through threaded holes (3.6, 3.12) which lodge threaded elements able to deform the thin layer area (3.4); said wing (3.2) of the retaining profile (3) facing towards the first wing (2.1) of the supporting profile (2) having at least two additional through threaded holes (3.7) located near the end of the wing (3.2) of the retaining profile (3), each one hosting the end of a screw (12); said longitudinal opening (2.8) present in the free end of the first wing (2.1) of the supporting profile (2) being facing towards the end of the wing (3.2) of the retaining profile (3); said opening (2.8) lodging a further slipper (5); a gasket (6) being interposed between the slipper (5) located in the free end of the first wing (2.1) and the free end of the wing (2.1) itself; said gasket (6) being constituted by a rectilinear elastic element.

2- Hinged structure for counters and cabinets, according to claim 1, characterized in that said wing (3.2) of the retaining profile (3) facing towards the first wing (2.1) of the supporting profile (2) having a first set of through threaded holes (3.6) having longitudinal axis orthogonal to that of the wing (3.2) that extend from the base of the wing (3.2) to its end; said threaded elements lodged within said first set of holes (3.6) consisting of studs (13) whose ends act in thrust against the free end of the wing (3.2) itself and cause its rotation in one direction by deforming the thin layer area (3.4).

3- Hinged structure for counters and cabinets, according to claim 1, characterized in that said wing (3.2) of the retaining profile (3) facing towards the first wing (2.1) of the supporting profile (2) having a fourth set of through threaded holes (3.12) having longitudinal axis orthogonal to that of the wing (3.2) itself that extend from one side of the wing to the other (3.2), near its thin layer area (3.4); said threaded elements located within said fourth set of holes (3.12) consisting of a countersunk head screws (14) whose countersunk heads deform the thin layer area (3.4).

4- Hinged structure for counters and cabinets, according to claim 1, characterized in that said slippers (5, 10) being constituted by extruded rectilinear elements in self-lubricating material.

5- Hinged structure for counters and cabinets, according to claim 1, characterized in that the head of said screws (12) inserted in the threaded holes (3.7) located near the ends of the wing (3.2) of the retaining profile (3) abuts on the supporting profile (2) by adjusting the verticality of the plate (1).

6- Hinged structure for counters and cabinets, according to claim 1, characterized in that at least a first wing (2.1) and at least a second wing (2.2) of the supporting profile (2) protruding from a closed chamber (2.4).

7- Hinged structure for counters and cabinets, according to claim 1, wherein said plate (1) being locked in the retaining profile (3) thanks to an insert (8) constituted by a rectilinear profile; said wing (3.2) of the retaining profile (3) facing towards the first wing (2.1) of the supporting profile (2) having a third set of through threaded holes (3.8) with longitudinal axis orthogonal to that of the wing (3.2); said holes (3.8) being crossed by screws (11) acting against the insert (8) which in turn pushes the lower part of the plate (1); said insert (8) is characterized by the fact of presenting on its upper wall a longitudinal opening (8.1) housing a frost-free panel; in the absence of said frost-free panel the opening of the slot (8.1) of the insert (8) being occupied by a longitudinal gasket (9).
